(19) United States
(12) Patent Application Publication
(10) Pub. No.: US 2024/0047747 A1
(43) Pub. Date: Feb. 8, 2024

(54) ZINC RECHARGEABLE BATTERIES

(71) Applicant: Seoul National University R&DB Foundation, Seoul (KR)

(72) Inventors: Jang Wook CHOI, Seoul (KR); Minkwan KIM, Seoul (KR)

(21) Appl. No.: 18/229,913

(22) Filed: Aug. 3, 2023

(30) Foreign Application Priority Data
Aug. 4, 2022 (KR) 10-2022-0097502

(51) Int. Cl. H01M 10/0567; H01M 10/36; H01M 10/02; H01M 10/0569; H01M 10/0568; H01M 4/38; H01M 4/60

(52) U.S. Cl. CPC H01M 10/0567; H01M 10/36; H01M 10/02; H01M 10/0569; H01M 10/0568; H01M 4/38; H01M 4/606; H01M 2004/027

(57) ABSTRACT

Disclosed is a zinc rechargeable battery, the zinc rechargeable battery including a positive electrode, a zinc-containing negative electrode, a separator between the positive electrode and the negative electrode, and an electrolyte, wherein the electrolyte includes a solvent, a zinc salt, and a low kₑₓ cation having a solvent exchange rate constant (kₑₓ) of less than or equal to about 10³ s⁻¹, and in the electrolyte, a molal concentration of the low kₑₓ cation in the electrolyte is lower than a molal concentration of a zinc ion.

### CROSS-REFERENCE TO RELATED APPLICATION

This application claims priority to and the benefit of Korean Patent Application No. 10-2022-0097502 filed in the Korean Intellectual Property Office on Aug. 4, 2022, the entire contents of which are incorporated herein by reference.

### BACKGROUND OF THE INVENTION

### (a) Field of the Invention

A zinc rechargeable battery is disclosed.

### (b) Description of the Related Art

Recently, demand for rechargeable batteries for being applied to the next generation energy storage systems, electric vehicles, etc. is increasing. Such rechargeable batteries are required to realize high electric power density and high safety. In this regard, aqueous and organic zinc rechargeable batteries are attracting lots of attentions as promising battery systems.

In general, the zinc rechargeable batteries consist of a zinc metal negative electrode, an organic/inorganic positive electrode, an aqueous/organic electrolyte, and a separator. Zinc is readily available, relatively inexpensive, and chemically stable and non-toxic in aqueous and organic solvents. In addition, the zinc is oxidized into Zn²⁺ without forming an intermediate phase during the battery operation, exhibits a high overpotential in a hydrogen evolution reaction (HER), has a redox potential of about −0.76 V vs. SHE suitable for the battery operation, and may realize high theoretical capacity (about 820 mAh/g, about 5854 mAh/L, a metal state).

However, the zinc rechargeable batteries have problems that zinc dendrites may grow on the surface of the negative electrode due to repeated charges and discharges and thus generates a short-circuit or significantly reduce usable capacity and that a zinc metal negative electrode may be corroded by a side reaction of an electrolyte, etc. and thus sharply reduce battery performance.

### SUMMARY OF THE INVENTION

The present invention is to suppress side reactions of an electrolyte in the zinc rechargeable batteries and also, suppress the dendrite growth on the zinc metal negative electrode surface to lead to uniform electrodeposition and stripping of the zinc and resultantly, improve reversibility of the zinc metal negative electrode, reduce irreversible capacity of the batteries, improve cycle-life characteristics and rate capability, and secure a low cost and fire stability.

In an embodiment, a zinc rechargeable battery includes a positive electrode, a zinc-containing negative electrode, a separator between the positive electrode and the negative electrode, and an electrolyte, wherein the electrolyte includes a solvent, a zinc salt, and a low kₑₓ cation having a solvent exchange rate constant (kₑₓ) of less than or equal to about 10³ s⁻¹, and a molal concentration of the low kₑₓ cation in the electrolyte is lower than a molal concentration of zinc ion.

In another embodiment, a zinc rechargeable battery includes a positive electrode, a zinc-containing negative electrode, a separator between the positive electrode and the negative electrode, and an electrolyte, wherein the electrolyte includes a solvent, a zinc salt, and a scandium cation.

In the zinc rechargeable battery according to an embodiment, a growth of zinc dendrite on the surface of the negative electrode may be suppressed, uniform electrodeposition and stripping of zinc may be induced on the negative electrode, and side reactions of the electrolyte may be suppressed to improve reversibility of the negative electrode, thereby improving cycle-life characteristics of the battery and performance such as rate capability.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a scanning electron microscope (SEM) image of the surface of the negative electrode of a battery cell of Example 1 after 5.5 cycles.

FIG. 2 is a SEM image of the surface of the negative electrode of a battery cell of Example 2 after 5.5 cycles.

FIG. 3 is a SEM image of the surface of the negative electrode of a battery cell of Comparative Example 2 after 5.5 cycles.

FIG. 4 is a SEM image of the surface of the negative electrode of a battery cell of Comparative Example 3 after 5.5 cycles.

FIG. 5 is a SEM image of the surface of the negative electrode of a battery cell of Comparative Example 4 after 5.5 cycles.

FIG. 6 is a SEM image of the surface of the negative electrode of a battery cell of Comparative Example 5 after 5.5 cycles.

FIG. 7 is a SEM image of the surface of the negative electrode of a battery cell of Example 3 after 2.5 cycles.

FIG. 8 is a SEM image of the surface of the negative electrode of a battery cell of Comparative Example 6 after 2.5 cycles.

FIG. 9 is a SEM image of the surface of the negative electrode of a battery cell of Comparative Example 8 after 2.5 cycles.

FIG. 10 is a graph showing coulombic efficiency according to the number of cycles of half cells of Examples 1 and 2 and Comparative Examples 1 to 5, to which an aqueous electrolyte is applied.

FIG. 11 is a graph showing coulombic efficiency according to the number of cycles of half cells of Example 3 and Comparative Examples 6 to 8, to which an organic electrolyte is applied.

FIG. 12 is graphs showing contents (density) of Zn²⁺ and added cations according to a distance on the negative electrode interfaces of symmetric cells of Comparative Example 1, Example 1, Example 2, and Comparative Example 3, which are sequentially from top to bottom, which are obtained by a cation concentration distribution analysis through a DFT-CES simulation.

FIG. 13 is a charge and discharge analysis (GCD) graph of the symmetric cells of Examples 1 and 2 and Comparative Examples 1 and 5.

FIG. 14 is an electrochemical impedance spectroscopy (EIS) graph of the symmetric cells of Examples 1, 2, 4, and 5 and Comparative Examples 1 and 5.

FIG. 15 is a graph showing a voltage change according to charging and discharging time of the symmetric cells of Comparative Example 1 and Example 4, to which an aqueous electrolyte is applied.

FIG. 16 is a graph showing a voltage change according to charging and discharging time of the symmetric cells of Example 6 and Comparative Examples 9 and 10 to which an aqueous-organic composite electrolyte is applied.

FIG. 17 is a graph showing a voltage change according to charging and discharging time of the symmetric cells of Example 3 and Comparative Example 6, to which an organic electrolyte is applied.

FIG. 18 is a photograph that confirms fire safety of a composite electrolyte of Example 6.

FIG. 19 is a photograph that confirms zinc metal corrosion inhibition ability of the composite electrolyte of Example 6.

FIG. 20 is a graph showing a voltage change according to charging and discharging time of the symmetric cells of Example 6 and Comparative Example 1 as low temperature safety evaluation results.

FIG. 21 is a graph showing discharge capacity and coulombic efficiency according to the number of cycles of full cells of Example 4 and Comparative Example 1.

FIG. 22 is a graph showing discharge capacity and coulombic efficiency according to the number of cycles of full cells of Example 6 and Comparative Example 9.

FIG. 23 is a graph showing a voltage change according to charging and discharging time of the symmetric cells of Example 7 and Comparative Examples 11 and 12, and FIG. 24 is a graph enlarged by adjusting a vertical axis range in the graph of FIG. 23.

FIG. 25 is a graph showing a voltage change according to charging and discharging time of the symmetric cells of Example 7 and Comparative Example 13.

### DETAILED DESCRIPTION OF THE EMBODIMENTS

Hereinafter, specific embodiments will be described in detail so that those skilled in the art can easily implement them. However, this disclosure may be embodied in many different forms and is not construed as limited to the example embodiments set forth herein.

The terminology used herein is used to describe embodiments only, and is not intended to limit the present invention. The singular expression includes the plural expression unless the context clearly dictates otherwise.

As used herein, “combination thereof” means a mixture, laminate, composite, copolymer, alloy, blend, reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

“Layer” herein includes not only a shape formed on the whole surface when viewed from a plan view, but also a shape formed on a partial surface.

The average particle diameter may be measured by a method well known to those skilled in the art, and for example, may be measured by a particle size analyzer, or may be measured by a transmission electron micrograph or a scanning electron micrograph. Alternatively, it is possible to obtain an average particle diameter value by measuring the size using a dynamic light scattering method, performing data analysis, counting the number of particles for each particle size range, and calculating from this. The average particle diameter may be measured with a microscope image or a particle size analyzer, and may mean a diameter (D50) of particles having a cumulative volume of 50 volume % in a particle size distribution.

Herein, “or” is not to be construed as an exclusive meaning, for example, “A or B” is construed to include A, B, A+B, and the like.

In an embodiment, a zinc rechargeable battery includes a positive electrode, a zinc-containing negative electrode, a separator between the positive electrode and the negative electrode, and an electrolyte, the electrolyte includes a solvent, a zinc salt, and a cation of low kₑₓ having a solvent exchange rate constant (kₑₓ) of less than or equal to about 10³ s⁻¹.

Electrolyte

A solvent exchange rate constant (kₑₓ) means a primary reaction constant of a reaction exchanged in the dynamic equilibrium of water molecules of a primary solvation shell with bulk water molecules and uses a unit of s⁻¹. Solvent exchange rate constants for various cations are known to be consulted. For reference, the solvent exchange rate constants may be obtained from Calculation Equation 1.

[M(H₂O)ₙ]^{m+}+H₂O*⇄[M(H₂O)ₙ₋₁H₂O*]^{m+}+H₂O Water exchange rate=nkₑₓ[{[M(H₂O)ₙ]^{m+}}] [Equation 1]

The solvent exchange rate constants may be measured in a nuclear magnetic resonance (NMR) spectroscopy method and specifically, through an analysis of existence, shift, and relaxation of peaks, etc. More information of the solvent exchange rate constants may be for example, found in Helv. Chim. Acta 2005 88 523-545 or Nippon Kagaku Kaishi 1983 10 1437-1441, etc.

In an embodiment, a cation with a low solvent exchange rate constant, for example, a cation with a solvent exchange rate constant (kₑₓ) of about 10³ s⁻¹ or less (hereinafter, referred to as “low kₑₓ cation”) is used to solve the problems that occur on the interface of the zinc metal negative electrode, for example, to suppress growth of zinc dendrite (dendritic phase) on the negative electrode interface but lead to uniform electrodeposition and stripping of zinc on the negative electrode and also, suppress corrosion of a zinc metal but increase usable capacity of a zinc rechargeable battery, significantly improving rate capability and cycle-life characteristics. The kₑₓ of the low kₑₓ cation may be, for example, about 10⁰ s⁻¹ to about 10³ s⁻¹, or about 10⁰ s⁻¹ to about 10² s⁻¹.

A cation with a high solvent exchange rate constant, for example, kₑₓ with greater than about 10³ s⁻¹, is relatively unstable in a solvent and has a flexible solvation shell (solvation shell), but the cation with a low solvent exchange rate constant is more stable and has a firm solvation shell. Accordingly, the cation having a low solvent exchange rate constant may not be easily disturbed or unstable by collisions with external complex ions but maintain a solvation space and position.

In a zinc rechargeable battery, the low kₑₓ cation is positioned on the surface of the zinc negative electrode during the battery operation or due to other electrical factors and particularly, locally present on small and large protrusions or pointed portions on the surface of the zinc negative electrode. However, since the low k ex cation has a firm and stable solvation shell, which may not be penetrated by a zinc ion (Zn²⁺) or a solvation shell of the zinc ion, zinc may be suppressed from intensive electrodeposition at a tip of the surface of the zinc negative electrode and thus from growth into zinc dendrite, which may result in leading uniform electrodeposition and stripping of the zinc. This effect may be realized in an organic electrolyte and a mixed electrolyte of the organic and aqueous electrolytes as well as the aqueous electrolyte.

The low kₑₓ cation may be, for example, a cation with the charge number of about 2+ or more, for example, the charge number of about 3+ or more. The greater the charge number, the stronger a repulsive action between cations. The low kₑₓ cation with the large charge number of about 2+ or more may effectively repel zinc ions, for example, effectively suppress the dendrite growth by pushing away intensive electrodeposition of the zinc ions on the protrusions of the surface of the zinc negative electrode.

The low kₑₓ cation may have a lower standard reduction potential (E° vs. SHE), based on a standard hydrogen electrode, than standard reduction (about −0.76 V) of zinc. In other words, the low kₑₓ cation has a lower standard reduction potential than zinc and has kₑₓ of about 10³ s⁻¹ or less.

The low kₑₓ cation may be, for example, Al³⁺, Sc³⁺, or a combination thereof but include any cation with kₑₓ in a range of about 10³ s⁻¹ or less.

The low kₑₓ cation may be present in the electrolyte and/or present on the surface of the negative electrode. Specifically, the low kₑₓ cation may be present in a form of a continuous film or an island on the surface of the negative electrode and adsorbed on zinc metals of the negative electrode. Or, the low kₑₓ cation may be distributed in the electrolyte and present both in the electrolyte and on the surface of the negative electrode.

In the electrolyte, zinc ions (Zn²⁺) derived from zinc salts may be active cations participating in reversible electrodeposition and stripping, and the low kₑₓ cation is a type of inactive cation not electrodeposited within a driving voltage range but leading uniform electrodeposition and stripping of the zinc ions. For example, Journal of the American Chemical Society 2020 142 (36) 15295-15304 describes an aluminum rechargeable battery using an aluminum-zinc alloy negative electrode and mentions a type of hybrid electrolyte prepared by adding both an aluminum salt and a zinc salt, which is an example of applying a hybrid electrolyte to a system using reversible electrodeposition and stripping of aluminum. An embodiment of the present invention, unlike this, discloses a zinc rechargeable battery using a zinc negative electrode, which is a system that zinc ions participate in reversible electrodeposition and stripping, wherein the low kₑₓ cation does not participate in the reversible electrodeposition and stripping but is mainly located on the surface of the negative electrode during the battery operation to leads to uniform electrodeposition and stripping of the zinc ions and to suppress growth of zinc dendrite

A molal concentration of the low kₑₓ cation in the electrolyte may be lower than a molal concentration of zinc ion. Herein, molal concentrations of ions means the number of moles of the corresponding ions present per about 1 kg of the electrolyte regardless of whether the ions are distributed in the electrolyte or present on the surface of the negative electrode. In addition, the zinc ion is a cation derived from the zinc salt. In an embodiment, for example, when the molal concentration of the low kₑₓ cation is higher than that of the zinc ion, battery performance may be sharply deteriorated under high-rate and high-capacity conditions.

For example, in the electrolyte, the molal concentration of the low kₑₓ cation may be about 0.5 times or less than that of the zinc ion. Such a content relationship thereof may realize stable operation of a high-capacity, high-rate, and high-current zinc rechargeable battery.

The molal concentration of the low kₑₓ cation and the molal concentration of zinc ion in the electrolyte may be about 1:2 to about 1:20, for example, about 1:2 to about 1:15, about 1:2 to about 1:10, about 1:2 to about 1:8, or about 1:2 to about 1:6, and when these ratios are satisfied, a high-capacity, high-rate, and high-current zinc rechargeable battery may be stably operated.

In the electrolyte, the molal concentration of the low kₑₓ cation may be about m to about 5 m, for example, about 0.1 m to about 4 m, about 0.1 m to about 3 m, about 0.1 m to about 2.5 m, about 0.1 m to about 2 m, or about 0.1 m about to 1.5 m, and when the ranges are satisfied, cycle-life characteristics of a zinc rechargeable battery may be significantly improved.

A molal concentration of zinc ion in the electrolyte may be about 0.1 m to about 30 m, for example, about 0.1 m to about 20 m, about 0.1 m to about 10 m, about 0.1 m to about 7 m, about 0.1 m to about 5 m, about 0.1 m to about 4 m, about m to about 3 m, or about 1 m to about 2.5 m. When the molal concentration of zinc ion satisfies the ranges, a zinc rechargeable battery may be stably operated.

Herein, since the zinc ion is derived from the zinc salt, the molal concentration of zinc ion may be expressed as a molal concentration of the zinc salt.

In the electrolyte, the zinc salt may include a zinc cation (Zn²⁺) and an anion, and the anion may be, for example, [N(CF₃SO₂)₂]⁻, [N(C₂F₅SO₂)₂]⁻, [N(C₂F₅SO₂)(CF₃SO₂)]⁻, CF₃SO₃⁻, C₂F₅SO₃⁻, SO₄²⁻, Cl⁻, CH₃CO₂⁻, or a combination thereof. These zinc salts are very stable and economical in the electrolyte and can contribute to improving battery performance.

The electrolyte according to an embodiment may be a conventional aqueous electrolyte or organic electrolyte used in a zinc rechargeable battery. The solvent of the electrolyte may be an aqueous solvent, an organic solvent, or a mixed solvent of an aqueous solvent and an organic solvent. The low kₑₓ cation achieves the same effect in any solvent such as an aqueous solvent, an organic solvent, or a mixed solvent thereof and accordingly, may be applied to any electrolyte solution system.

The aqueous electrolyte may include water, an alcohol-based solvent, or a combination thereof, for example, distilled water or deionized water. The aqueous electrolyte may exhibit about 100 times to about 1000 times higher ionic conductivity than a conventional organic electrolyte and thus significantly increase a movement speed of zinc ions, thereby improving rate characteristics of a battery and dramatically increasing a charging rate. In addition, the aqueous electrolyte, unlike the conventional organic electrolyte, may have a low risk of explosion and fire, thereby securing battery safety.

The organic solvent may also be referred to as a non-aqueous organic solvent, and examples thereof may include nitrile solvents such as acetonitrile, propionitrile, and butyronitrile; carbonate solvents such as dimethyl carbonate, diethyl carbonate, dipropyl carbonate, methylethyl carbonate, methylpropyl carbonate, ethylpropyl carbonate, ethylene carbonate, propylene carbonate, and butylene carbonate; ketone solvents such as acetone and cyclohexanone; alcohol solvents such as methanol, ethanol, propanol, and isopropanol; amide solvents such as N,N-dimethylformamide and N,N-dimethylacetamide; carbamate solvents such as 3-methyl-2-oxazolidone; and sulfur-containing compound-based solvents such as sulfolane, dimethyl sulfoxide, and 1,3-propanesultone.

An embodiment provides, as a specific example, a zinc rechargeable battery including a positive electrode, a zinc-containing negative electrode, a separator between the positive electrode and the negative electrode, and an electrolyte, wherein the electrolyte includes an aqueous solvent, a zinc salt, and an Al³⁺ cation, and the Al³⁺ cation has a lower molal concentration than zinc ion. Herein, the molal concentration of Al³⁺ cation and the molal concentration of zinc ion may be about 1:2 to about 1:20 or about 1:2 to about 1:10. The zinc rechargeable battery according to an embodiment, since uniform electrodeposition and stripping of zinc is induced, while growth zinc dendrite is effectively suppressed, exhibits improved cycle-life characteristics.

An embodiment provides, as another example, a zinc rechargeable battery including a positive electrode, a zinc-containing negative electrode, a separator between the positive electrode and the negative electrode, and an electrolyte, wherein the electrolyte includes a solvent, a zinc salt, and a Sc³⁺ cation. Herein, the solvent may be an aqueous solvent, an organic solvent, or a mixed solvent thereof. The zinc rechargeable battery according to an embodiment, since uniform electrodeposition and stripping of zinc is induced, while growth zinc dendrite is effectively suppressed, also exhibits increased usable capacity and significantly improved rate capability and cycle-life characteristics.

### Negative Electrode

The negative electrode according an embodiment may include a zinc-containing material, for example, a zinc metal or a zinc alloy. Herein, the alloy may include at least one element selected from Al, B, Ba, Ca, Ce, Co, Cr, Cu, F, Fe, Mg, Mn, Ni, P, S, Si, Sr, Ti, V, W, In, Ag, Au, Hg, Sn, and Zr in addition to the zinc. The negative electrode may be in a form of a metal foil or powder coated on a substrate, for example, a zinc metal foil, zinc powder, zinc-containing conductive powder, etc. The zinc-containing conductive powder may be powder including a carbon material, a silicon-based material, or a combination thereof in addition to the zinc.

The negative electrode may be manufactured by preparing the zinc-containing metal foil or by mixing the zinc powder or the zinc-containing conductive powder with a binder and a solvent and then, applying and drying the mixture on a current collector.

### Positive Electrode

In an embodiment, a positive electrode may be any positive electrode used in a zinc rechargeable battery without a particular limit. For example, the positive electrode may include a current collector and a positive electrode active material layer on the current collector, wherein the positive electrode active material layer may include a positive electrode active material and optionally, a binder and/or a conductive material.

The positive electrode active material may be, for example, an inorganic positive electrode active material, an organic positive electrode active material, or a combination thereof. The inorganic positive electrode active material may include a metal oxide, wherein a metal may be at least one selected from Co, Ni, Mn, V, and Zn. The metal oxide may further include at least one element selected from Ag, Bi, Ca, Cu, Fe, K, Li, Na, Si, Sn, Ti, and Y. For example, the positive electrode active material may include a vanadium-containing positive electrode active material, for example, a vanadium oxide, for example, V₆O₁₃ having a three-dimensional crystal structure.

The organic positive electrode active material may be a compound which is made of carbon and hydrogen and optionally, includes an element such as oxygen, nitrogen, sulfur, halogen, etc. and a redox active organic material (ROMs). The organic positive electrode active material may be, for example, a phenazine-based compound, a phenothiazine-based compound, a phenoxazine-based compound, and the like but is not limited thereto. The organic positive electrode active material may be, for example, dimethylphenazine (DMPZ), triangular phenanthrenequinone-based macrocycle (PQ delta), dibenzo[b,i]thianthrene-5,7,12,14-tetraone (DTT), cailx[4]quinone (04Q), phenanthrenequinone macrocyclic trimer (PQ-MCT), diquinoxalino[2,3-a:2′,3′-c]phenazine (HATN), 1,4-bis(diphenylamino)benzene (BDB), P-chloranil, pyrene-4,5,9,10-tetraone (PTO), 3,4,9,10-perylenetetracarboxylic dianhydride (Pi-PMC), and the like.

The positive electrode active material may be included in an amount of about 50 wt % to about 100 wt % based on 100 wt % of the positive electrode active material layer, for example, about 50 wt % to about 99.8 wt %, about 60 wt % to about 98 wt %, or about 70 wt % to about 95 wt %. Within the ranges, excellent processibility may be maintained without deteriorating capacity.

The binder may be, for example, polyvinylidene fluoride, polyvinyl alcohol, carboxylmethyl cellulose, starch, hydroxypropyl cellulose, regenerated cellulose, polyvinylpyrrolidone, tetrafluoroethylene, polyethylene, polypropylene, ethylene-propylene-diene polymer (EPDM), sulfonated EPDM, a styrene butadiene rubber, a fluorine rubber, and the like. The binder may be included in an amount of about 0.1 wt % to about 20 wt %, about 0.1 wt % to about 15 wt %, or about 0.1 to about 10 wt % based on 100 wt % of the positive electrode active material layer, and within the content ranges, an appropriate binding force may be achieved without deteriorating capacity.

Examples of the conductive material may include a carbon-based material such as natural graphite, artificial graphite, carbon black, acetylene black, ketjen black, carbon fiber, carbon nanofiber, and carbon nanotube; a metal-based material containing copper, nickel, aluminum, silver, etc., in the form of a metal powder or a metal fiber; a conductive polymer such as a polyphenylene derivative; or a combination thereof. The conductive agent may be included in an amount of about to about 40 wt %, about 0.1 wt % to about 30 wt %, about 0.1 wt % to about 25 wt %, or about 1 wt % to about 20 wt % based on 100 wt % of the positive electrode active material layer, and within the content ranges, appropriate electron conductivity may be realized without deteriorating capacity.

The positive electrode current collector is not particularly limited but may include, for example, stainless steel, aluminum, nickel, titanium, pyrolytic graphite, or the aluminum or stainless steel surface-treated with carbon, nickel, titanium, silver, and the like and have a thickness of about 3 μm to about 100 μm. On the surface of the positive electrode current collector, fine concavo-convex may be formed to increase adherence of the positive electrode active material, which may have various forms of a film, a sheet, a foil, a net, a porous body, a foam, a non-woven fabric, and the like.

### Separator

A separator is to separate the positive and negative electrodes and provide a passage for zinc ion to move and may be any separator generally used in a zinc rechargeable battery without particular limitation. The separator may have low resistance to movement of zinc ion but excellent impregnation ability for an electrolyte. For example, the separator may include glass fiber, polyester, polyethylene, polypropylene, polytetrafluoroethylene, or a combination thereof, and may be in the form of a nonwoven fabric or fabric. The separator may have a thickness of about 5 to about 300 μm. The separator may have a single-layer or multi-layer structure, and may be coated with a ceramic component or a polymer material to secure heat resistance and mechanical strength.

A zinc rechargeable battery according to an embodiment may be cylindrical, prismatic, thin film, or the like, and may be, for example, a large thin film type. Since the zinc rechargeable battery realizes high capacity, excellent rate capability, and excellent cycle-life characteristics, it can be applied to various energy storage systems, notebook computers, mobile devices, portable electronic devices, and electric vehicles.

### EXAMPLES

Hereinafter, examples of the present invention and comparative examples are described. It is to be understood, however, that the examples are for the purpose of illustration and are not to be construed as limiting the present invention.

Table 1 shows a redox pair, charge density, a standard reduction potential E° based on a standard hydrogen electrode, and a solvent exchange rate constant (kₑₓ) for various metal elements. Each figure of Table 1 is obtained with reference to “Electrochemical Methods: Fundamentals and Applications 2^{nd} Edition”, “Descriptive Inorganic Chemistry 5th Edition”, “Helv. Chim. Acta 2005 88 523-545”, or “Nippon Kagaku Kaishi 1983 10 1437-1441,” etc.

TABLE 1

| Metal | Redox | Charge density | E⁰ | kₑₓ |
|---|---|---|---|---|
| element | pair | (C/mm) | (V, vs. SHE) | (s⁻¹) |
| Li | Li⁺/Li | 52 | −3.04 | 10⁸-10⁹ |
| Pt | Pt²⁺/Pt | 92 | 1.19 | −10⁻⁴ |
| Zn | Zn²⁺/Zn | 112 | −0.76 | −4 × 10⁷ |
| Ca | Ca²⁺/Ca | 52 | −2.87 | −10⁸ |
| Cr | Cr³⁺/Cr | 261 | −0.74 | −10⁻⁶ |
| Yb | Yb³⁺/Yb | 111 | −2.19 | −10⁷ |
| Gd | Gd³⁺/Gd | 91 | −2.28 | −10⁹ |
| Al | Al³⁺/Al | 364 | −1.66 | −10⁰ |
| Sc | Sc³⁺/Sc | 163 | −2.08 | −10² |

### Example 1

1. Preparation of Electrolyte

An electrolyte of Example 1 is prepared by dissolving Zn(CF₃SO₃)₂ at a concentration of 2 m and Sc(CF₃SO₃)₃ at a concentration of 0.5 m in deionized water.

2-1. Manufacture of Zn—Cu Half-cell

A half-cell is manufactured by using a zinc metal foil (Goodfellow Corp.) as a negative electrode and a copper metal foil as a counter electrode, interposing a 0.26 mm-thick glass fiber separator therebetween, inserting them into a battery case, and then, injecting an electrolyte thereinto.

2-2. Manufacture of Zn/Zn Symmetric Cells

A zinc/zinc symmetric cell is manufactured as follows, separately from the half-cell. The zinc symmetric cell is manufactured by using a zinc metal foil (Goodfellow Corp.) as a positive electrode and a negative electrode, interposing a glass fiber separator therebetween, inserting them in a battery case, and injecting an electrolyte thereinto.

2-3. Manufacture of Full Cells

A full cell is manufactured, separately from the half-cell and the symmetric cell. A positive electrode active material composition is prepared by mixing PQ-MCT as an organic positive electrode active material, carbon black (Super-P), and polyvinylidene fluoride in a weight ratio of 6:3:1 in an N-methylpyrrolidone solvent. The positive electrode active material composition is applied in a loading amount of mg/cm² onto a pyrolytic graphite foil and dried, preparing a positive electrode. A zinc metal foil (Goodfellow Corp.) is prepared as a negative electrode. After cutting the prepared positive and negative electrodes, each full cell is manufactured by interposing a glass fiber separator therebetween, inserting them into a battery case, and injecting an electrolyte thereinto.

### Example and Comparative Example

Hereinafter, electrolytes and various cells according to Examples 2 and 3 and Comparative Examples 1 to 8 are respectively manufactured by changing the concentration of zinc ion (zinc salt) and the type of added cation and the type of electrolyte as shown in Tables 2 and 3.

The following added cation is added to the electrolyte in the form of salts combined with (CF₃SO₃)⁻ anions. The following organic electrolyte uses acetonitrile instead of the deionized water as a solvent, and a polyethylene separator is used as a separator to a battery to which the organic electrolyte is used.

Hereinafter, the cations (Sc³⁺, Al³⁺) used in the examples have a relatively small kₑₓ value of less than or equal to 10³ s⁻¹, as shown in Table 1, while the cations used in Comparative Examples 2 to 5 and 8 have a relatively large kₑₓ value of greater than or equal to about 10⁷.

TABLE 2

| | Zinc ion | Added cation | Electrolyte |
|---|---|---|---|
| Example 1 | 2 m Zn²⁺ | 0.5 m Sc³⁺ | aqueous |
| Example 2 | 2 m Zn²⁺ | 0.5 m Al³⁺ | aqueous |
| Comparative Example 1 | 2 m Zn²⁺ | — | aqueous |
| Comparative Example 2 | 2 m Zn²⁺ | 0.5 m Li⁺ | aqueous |
| Comparative Example 3 | 2 m Zn²⁺ | 0.5 m Ca²⁺ | aqueous |
| Comparative Example 4 | 2 m Zn²⁺ | 0.5 m Yb³⁺ | aqueous |
| Comparative Example 5 | 2 m Zn²⁺ | 0.5 m Gd³⁺ | aqueous |

TABLE 3

| | Zinc ion | Added cation | Electrolyte |
|---|---|---|---|
| Example 3 | 0.5 m Zn²⁺ | 0.25 m Sc³⁺ | organic |
| Comparative Example 6 | 0.5 m Zn²⁺ | — | organic |
| Comparative Example 7 | 1.0 m Zn²⁺ | — | organic |
| Comparative Example 8 | 0.5 m Zn²⁺ | 0.25 m Li⁺ | organic |

### Evaluation Example 1: Surface Analysis of Negative Electrode

The half cells of Examples 1 and 2 and Comparative Examples 1 to 5 are 5.5 times cycled at a rate of 5 mA cm⁻² with capacity of 0.5 mAh cm⁻², and then, their negative electrode surfaces are examined. In addition, the symmetric cells of Example 3 and Comparative Examples 6 and 8 are 2.5 times cycled at a rate of 1 mA cm⁻² with capacity of 1 mAh cm⁻², and their negative electrode surfaces are examined.

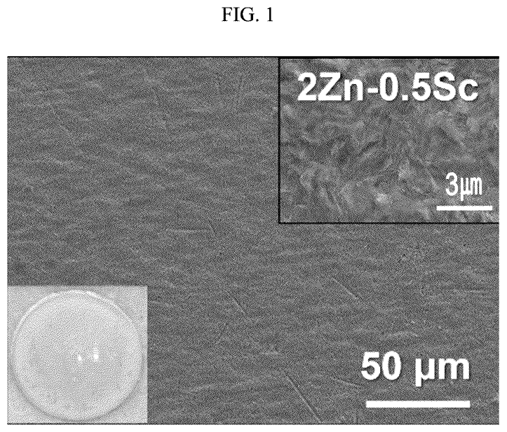

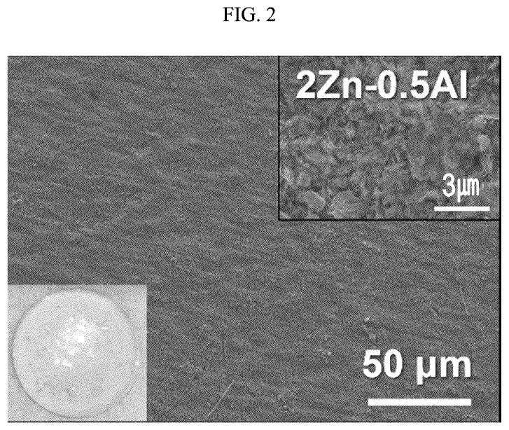

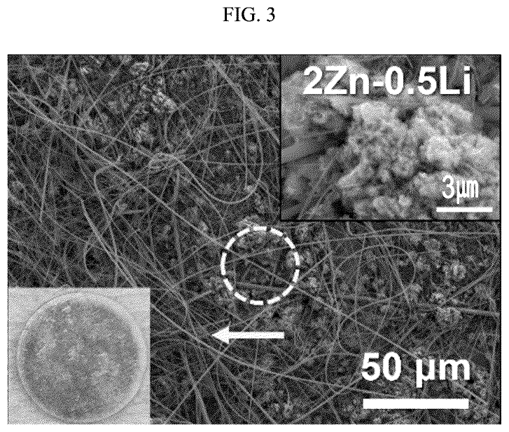

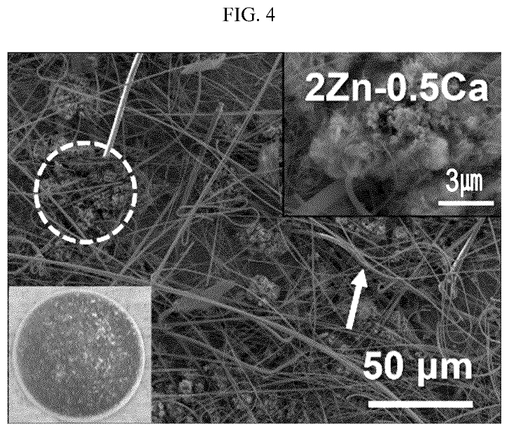

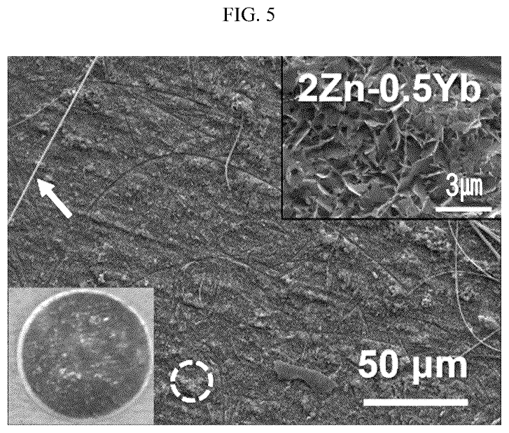

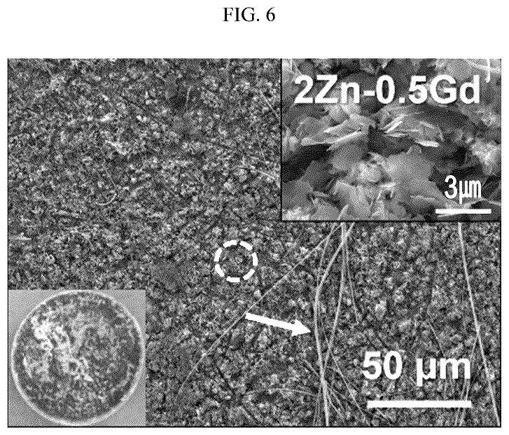

FIG. 1 is a SEM image of the surface of the negative electrode of Example 1, FIG. 2 is a SEM image of the surface of the negative electrode of Example 2, FIG. 3 is a SEM image of the surface of the negative electrode of Comparative Example 2, FIG. 4 is a SEM image of the surface of the negative electrode of Comparative Example 3, FIG. 5 is a SEM image of the surface of the negative electrode of Comparative Example 4, and FIG. 6 is a SEM image of the surface of the negative electrode of Comparative Example 5. In FIGS. 1 to 9 to be described later, a picture at the bottom left is a real picture taken without magnification of the negative electrode sides of the battery cells after 5.5 cycles or 2.5 cycles.

Comparing FIGS. 1 to 6 showing the examples to which an aqueous electrolyte is applied, Example 1 and 2 (FIGS. 1 and 2) in which Sc³⁺ and Al³⁺ cations, which are low kₑₓ cations, are added, exhibit very uniform Zn electrodeposition. On the contrary, in the comparative examples of FIGS. 3 to 6, no uniform Zn electrode position is achieved

In FIGS. 3 to 6, a dotted circle indicates an agglomerate formed as zinc grows into a dendrite, wherein an arrow mark points a glass fiber fragment broken off from a separator twisted by the zinc dendrite.

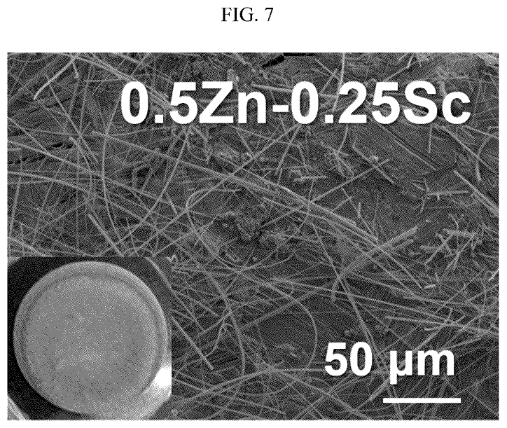

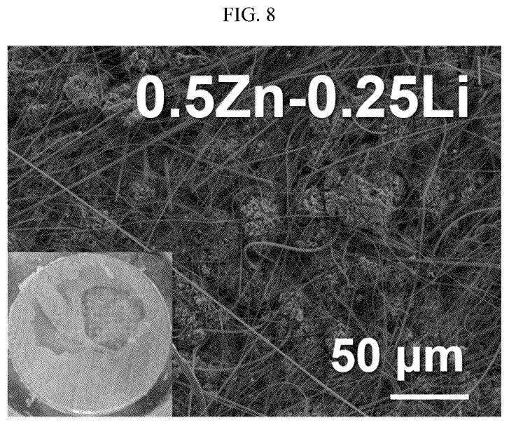

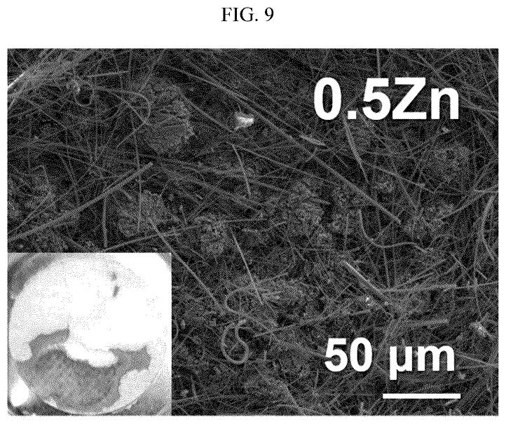

In addition, FIG. 7 shows a SEM image of the surface of the negative electrode of Example 3, FIG. 8 shows a SEM image of the surface of the negative electrode of Comparative Example 6, and FIG. 9 shows a SEM image of the surface of the negative electrode of Comparative Example 8. Referring to FIGS. 7 to 9 showing the examples to which an organic electrolyte is applied, Example 3 in which Sc³⁺ cation is added exhibits very uniform Zn electrodeposition.

### Evaluation Example 2: Evaluation of Half-cell Reversibility

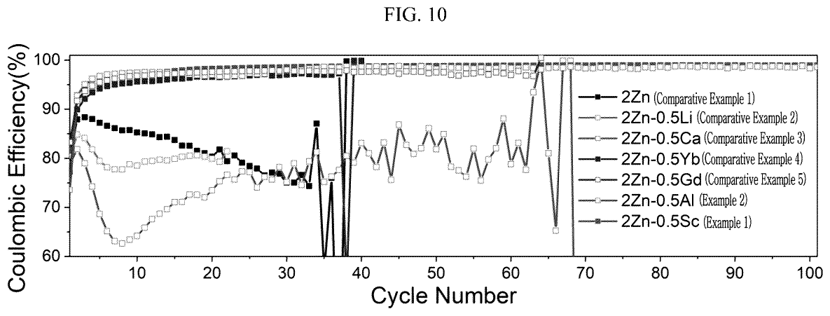

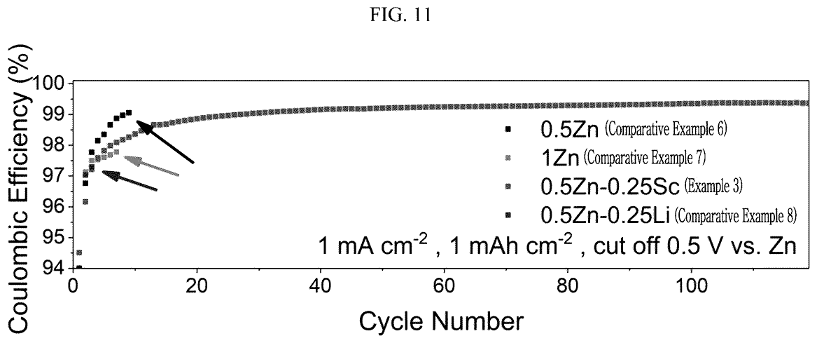

The half cells according to Examples 1 to 3 and Comparative Examples 1 to 8 are evaluated with respect to coulombic efficiency, while 100 times or more repeatedly charged and discharged under a condition of cut-off 0.5 V vs. Zn discharging after charging at a rate of 1 mA cm⁻² with capacity of 1 mAh cm⁻², and the results are shown in FIGS. 10 and 11. FIG. 10 is a graph of Examples 1 and 2 and Comparative Examples 1 to 5 to which an aqueous electrolyte is applied, and FIG. 11 is a graph of Example 3 and Comparative Examples 6 to 8 to which an organic electrolyte is applied.

Referring to FIG. 10, Examples 1 and 2, in which low kₑₓ cations are added to the aqueous electrolyte, exhibit very high coulombic efficiency at 100 cycles or more, while maintaining high reversibility. On the contrary, Comparative Example 1 using no cation additive and Comparative Examples 2 to 5 using cations with kₑₓ of 10⁷ s⁻¹ or more exhibit sharply deteriorated coulombic efficiency during the cycles and thus deteriorated battery reversibility.

Referring to FIG. 11, in the case of applying an organic electrolyte, Example 3, in which low kₑₓ cations are added, maintains very high coulombic efficiency at the 100 cycles or more and thus exhibits high reversibility, but Comparative Examples 6 and 7 using no cation additive and Comparative Example 8 in which Li⁺ cations with kₑₓ of 10⁸ to 10⁹ s⁻¹ maintain no coulombic efficiency before 10 cycles but have an internal short circuit and thus exhibit very low reversibility.

### Evaluation Example 3: Interfacial Distribution and Electrochemical Analysis of Cationic Additives

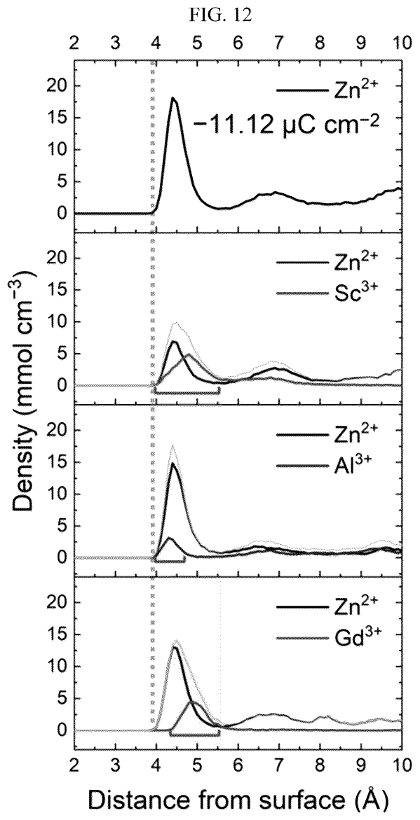

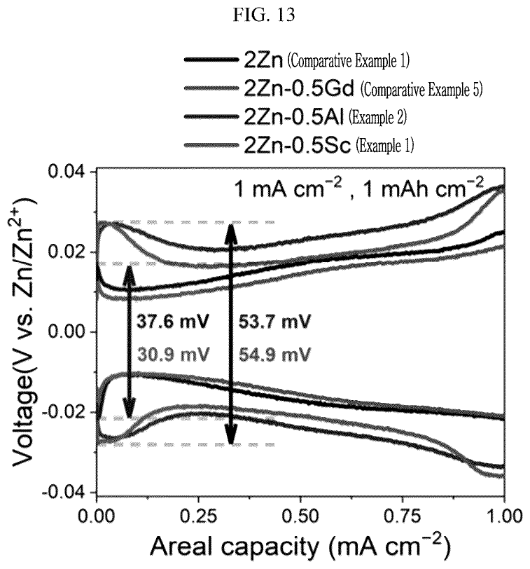

Through DFT-CES (density functional theory in classical explicit solvent) simulation analysis under a polarization condition of −0.03 V, a local density profile from the surface of the negative electrode to an electrolyte direction, that is, a concentration profile of zinc ion and added cation is analyzed, and the results are shown in FIG. 12. FIG. 12 shows an analysis graph of Comparative Example 1, Example 1, Example 2, and Comparative Example 5 sequentially from top to bottom.

Referring to FIG. 12, Sc³⁺ and Al³⁺ with low kₑₓ are not pushed out by Zn²⁺ ion entering the interface but positioned on the interface, but Gd³⁺ with high kₑₓ has a weak hydration shell and is pushed by Zn²⁺ and starts to exist relatively farther away from the electrode interface. Accordingly, the low kₑₓ cation leads to uniform zinc electrodeposition by controlling electrodeposition of zinc ion on the negative electrode interface.

In addition, a galvanostatic charge discharge (GCD) analysis of the symmetric cells manufactured by respectively applying the electrolytes of Examples 1 and 2 and Comparative Examples 1 and 5 is conducted at the second cycle, and the results are shown in FIG. 13.

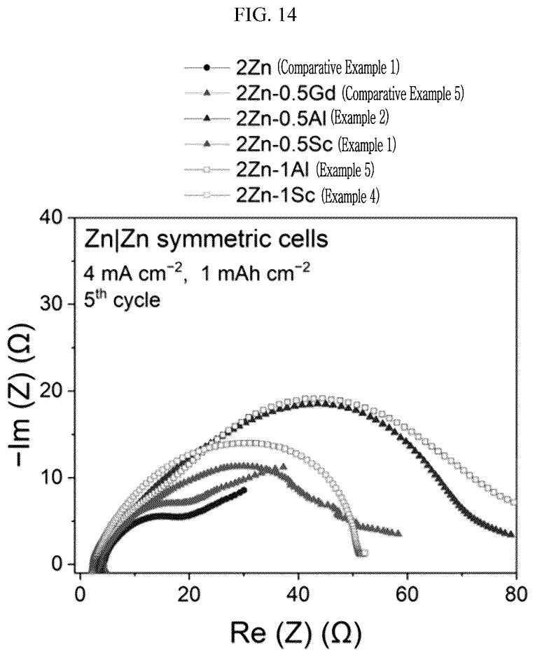

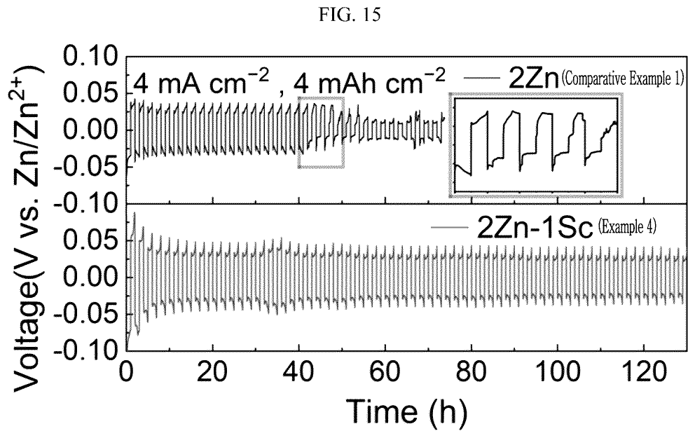

Furthermore, the symmetric cells manufactured by applying the electrolytes of Examples 1 and 2 and Comparative Examples 1 and 5 and also, Examples 4 and shown in Table 4 are cycled under conditions of 4 mA/cm² and 1 mAh/cm², and then, an electrochemical impedance spectroscopy (EIS) analysis of the cells is performed at the 5th cycle, and the results are shown in FIG. 14.

(Table 4)

TABLE 4

| | Zinc ion | Added cation | Electrolyte |
|---|---|---|---|
| Example 4 | 2 m Zn²⁺ | 1 m Sc³⁺ | aqueous |
| Example 5 | 2 m Zn²⁺ | 1 m Al³⁺ | aqueous |

Referring to FIGS. 13 and 14, the examples exhibit significantly increased overvoltage and thus increased charge transfer resistance on the interface, compared with the comparative examples. Accordingly, the low kₑₓ cation according to one embodiment is present on the surface of the zinc metal negative electrode by an electric field, that is, on the interface of the negative electrode with the electrolyte and thus affect the interface.

### Evaluation Example 4: Evaluation of Reversibility of Symmetric Cell

(1) Aqueous Electrolyte

Each zinc/zinc symmetric cell manufactured by respectively applying the electrolytes of Comparative Example 1 and Example 4 are repeatedly charged and discharged at 4 mA/cm² and 4 mAh/cm² and then, measured with respect to voltage changes according to time, and the results are shown in FIG. 15.

Referring to FIG. 15, Comparative Example 1 using no cation additive exhibits deteriorated performance after 40 hours, but Example 4 using the cation additive according to one embodiment maintains excellent performance even after 120 hours and thus excellent reversibility.

(2) Aqueous-Organic Composite Electrolyte

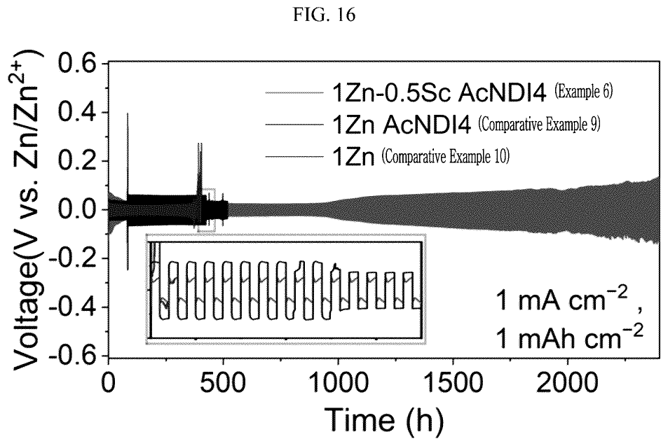

An electrolyte and a symmetric cell are manufactured in the same manner as in Example 1 except that the electrolyte is designed to use a composite solvent prepared by mixing acetonitrile and deionized water in a molar ratio of 1:4 as shown in Table 5. Subsequently, the cell is charged and discharged under conditions of 1 mA/cm² and 1 mAh/cm² and then, measured with respect to voltage changes according to time, and the results are shown in FIG. 16.

TABLE 5

| | Zinc ion | Added cation | Electrolyte |
|---|---|---|---|
| Example 6 | 1 m Zn²⁺ | 0.5 m Sc³⁺ | composite |
| Comparative Example 9 | 1 m Zn²⁺ | — | composite |
| Comparative Example 10 | 1 m Zn²⁺ | — | aqueous |

Referring to FIG. 16, the cell of Example 6 exhibits satisfactory battery performance even after 2000 hours and thus high reversibility, compared with the cells of the comparative examples.

(3) Organic Electrolyte

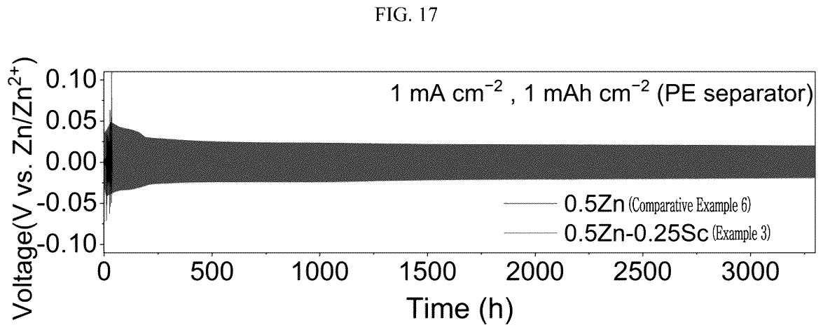

The symmetric cells of Example 3 and Comparative Example 6 are charged and discharged in the same manner as the cases using the aqueous electrolyte and then, measured with respect to voltage changes according to time, and the results are shown in FIG. 17. Referring to FIG. 17, unlike the cell of Comparative Example 6, the cell of Example 3 exhibits excellent battery performance even after 3000 hours and thus realizes high reversibility.

### Evaluation Example 5: Evaluation of Electrolyte Safety

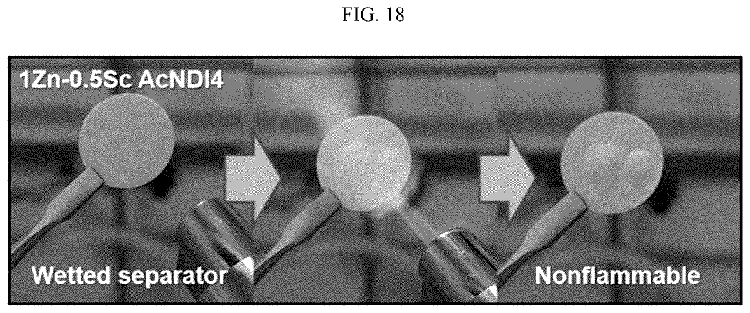

The aqueous-organic composite electrolyte of Example 6 is checked with respect to fire safety. As shown in FIG. 18, as a result of an experiment of heating a separator wetted with the corresponding electrolyte by a torch, there is neither combustion nor ignition. Accordingly, the electrolyte according to one embodiment turns out to have excellent fire safety.

### Evaluation Example 6: Evaluation of Corrosion Inhibition Ability of Electrolyte

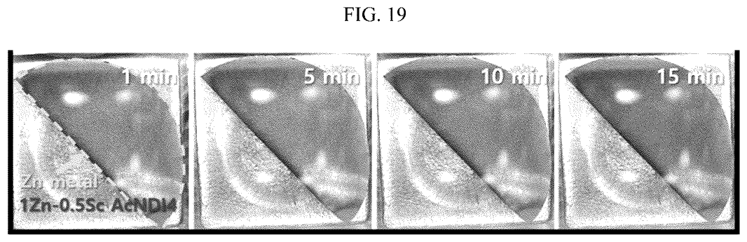

The electrolyte of one embodiment is checked with respect to zinc metal corrosion inhibition ability. FIG. 19 shows photographs of a zinc metal negative electrode to which the aqueous-organic composite electrolyte of Example 6 is applied, that is, the photographs from left to right sequentially show the zinc metal surface after allowed to stand for 1 minute, 5 minutes, 10 minutes, and 15 minutes after contacting the electrolyte.

Referring to FIG. 19, there is no corrosion on the zinc negative electrode at all. Accordingly, the electrolyte according to one embodiment turns out to have ability of suppressing corrosion of zinc metals.

### Evaluation Example 7: Evaluation of Low-Temperature Stability of Composite Electrolyte

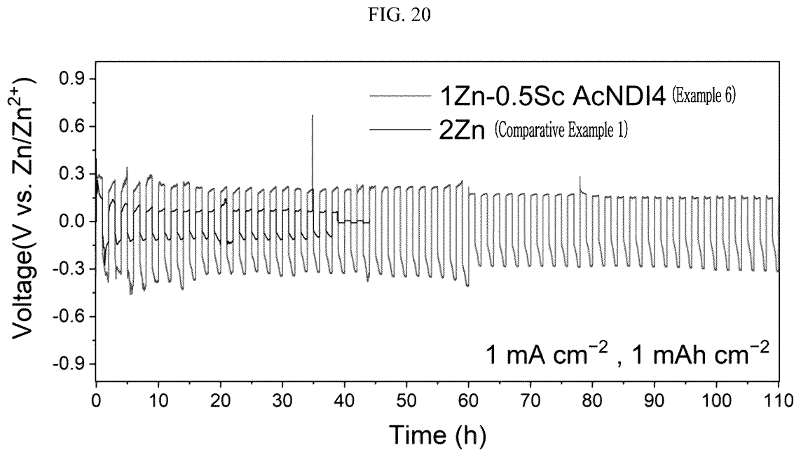

The symmetric cell to which the composite electrolyte of Example 6 is applied and the symmetric cell of Comparative Example 1 are charged and discharged in the same method as in Evaluation Example 4 and then, measured with respect to voltage changes according to time by repeating charges and discharges at a low temperature of −40° C., and the results are shown in FIG. 20. Referring to FIG. 20, unlike the symmetric cell of Comparative Example 1, the symmetric cell of Example 6 maintains excellent performance even after 110 hours and thus may stably operate at the low temperature.

### Evaluation Example 8: Evaluation of Constant Current Performance of Full Cell

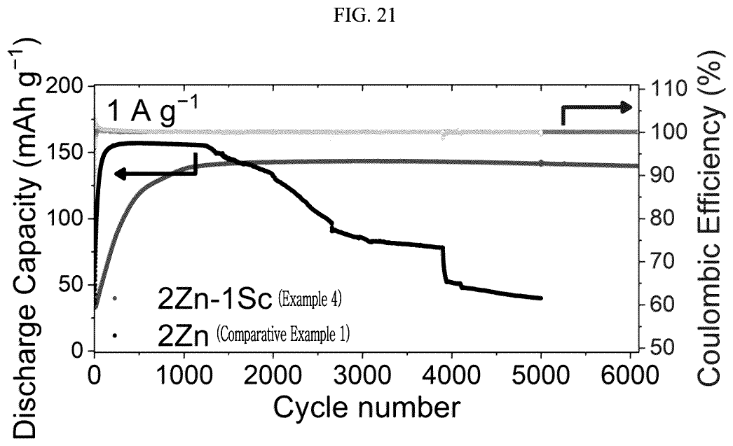

A full cell to which the electrolyte of Example 4 is applied and a full cell to which the electrolyte of Comparative Example 1 are initially charged and discharged within a voltage range of 0.4 to 1.7 Vat 100 mA g⁻¹ and then, repeatedly 6000 times charged and discharged with the same voltage range at 1 A g⁻¹ or more to measure discharge capacity (left vertical axis) and coulombic efficiency (right vertical axis) according to the number of cycles, and the results are shown in FIG. 21.

Referring to FIG. 21, unlike the full cell of Comparative Example 1, the cell of Example 4 maintains excellent performance even to the 6000 cycles and thus realizes excellent cycle-life characteristics.

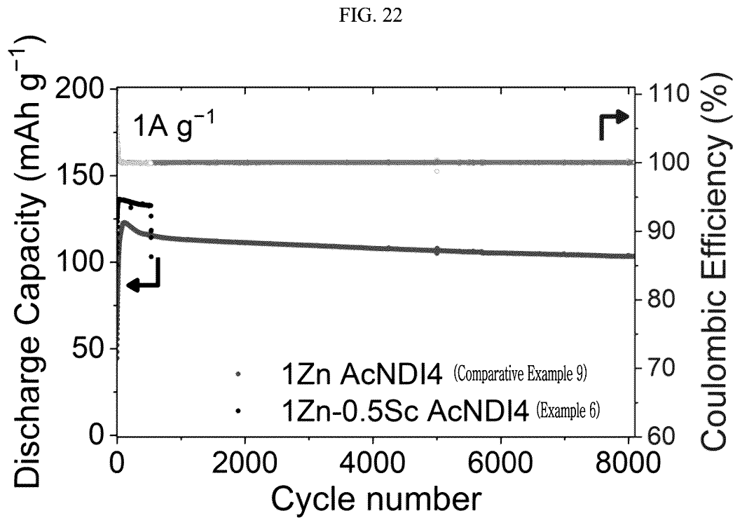

In addition, each full cell manufactured by respectively applying the composite electrolytes of Example 6 and Comparative Example 9 is initially charged and discharged within a voltage range of 0.4 to 1.7 Vat 100 mA g⁻¹ and then 8000 times or more charged and discharged within the same voltage range at 1 A g⁻¹ and then, measured with respect to discharge capacity (left vertical axis) and coulombic efficiency (right vertical axis) according to cycles, and the results are shown in FIG. 22.

Referring to FIG. 22, unlike the cell of Comparative Example 9, the cell of Example 6 maintains excellent performance even to the 8000 cycles and thus significantly improved cycle-life characteristics.

### Evaluation Example 9: Evaluation of Battery Cell Performance According to Cation Content Ratio

A Zn/Zn symmetric cell is manufactured in the same manner as in Example 1 except that the electrolyte is designed as shown in Table 6. These symmetric cells are repeatedly charged and discharged at 4 mA/cm² and 4 mAh/cm² and then, measured with respect to voltage changes according to time.

TABLE 6

| | Zinc ion | Added cation | Electrolyte |
|---|---|---|---|
| Comparative Example 11 | 2 m Zn²⁺ | 2 m Al³⁺ | aqueous |
| Comparative Example 12 | 2 m Zn²⁺ | 1.5 m Al³⁺ | aqueous |
| Comparative Example 13 | 1 m Zn²⁺ | 1 m Al³⁺ | aqueous |
| Example 7 | 2 m Zn²⁺ | 1 m Al³⁺ | aqueous |

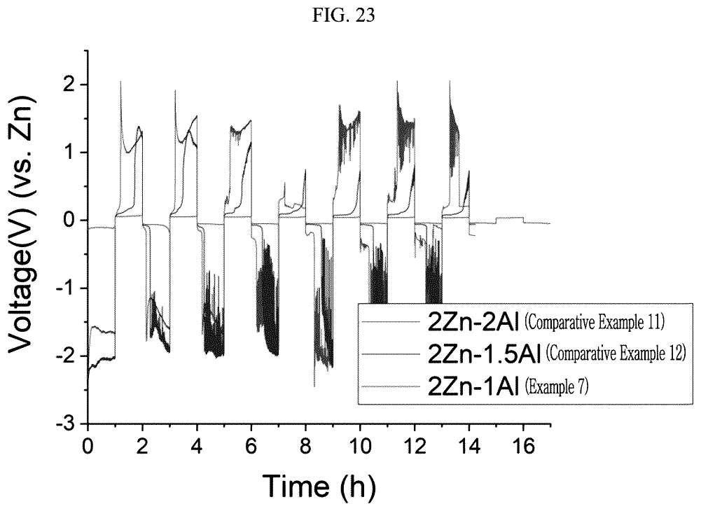

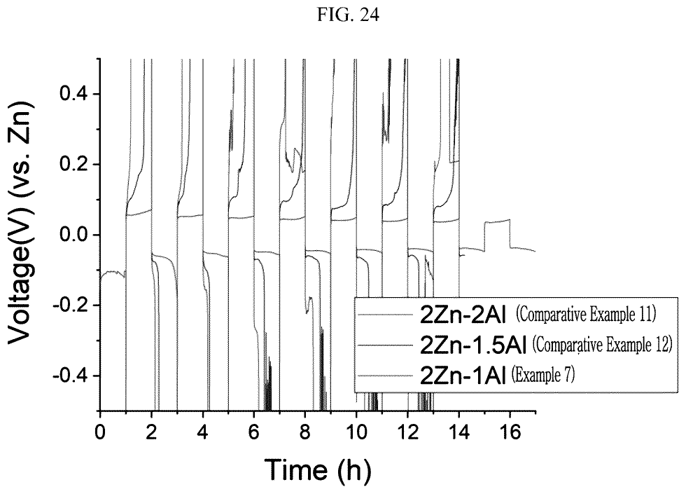

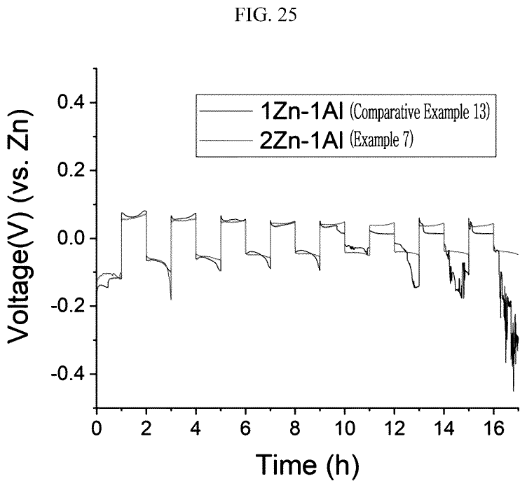

FIGS. 23 and 24 are graphs showing the symmetric cells of Comparative Examples 11 and 12 and Example 7. FIG. 25 is a graph showing the symmetric cells of Comparative Example 13 and Example 7. Referring to FIGS. 23 to 25, Example 7 alone maintains excellent performance at a high rate and high capacity. As shown in the comparative examples, when a molar content of the added cation such as Al³⁺ and the like relative to that of the zinc ion exceeds a certain level, the transference number for Zn²⁺ decreases, resulting in being impossible to operate under high-rate and high-capacity conditions. Accordingly, a smaller molar content of added cation to an electrolyte, for example, a smaller molar content of Al³⁺ cation than that of zinc ion may be advantageous for battery performance. Specifically, when the molar content of the added cation such Al³⁺ and the like to the electrolyte satisfies 0.5 times or less of that of the zinc ion, that is, when the added cation and the zinc ion have a molal concentration ratio of 1:2 or more, for example, 1:2 to 1:20, it is possible to secure stable operation of a zinc rechargeable battery with high rate, high current, and high capacity.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. A zinc rechargeable battery, comprising
a positive electrode,
a zinc-containing negative electrode,
a separator between the positive electrode and the negative electrode, and
an electrolyte,
wherein the electrolyte includes a solvent, a zinc salt, and a low kₑₓ cation having a solvent exchange rate constant (kₑₓ) of less than or equal to about 10³ s⁻¹, and
a molal concentration of the low kₑₓ cation in the electrolyte is lower than a molal concentration of a zinc ion.

2. The zinc rechargeable battery of claim 1, wherein
a charge number of the low kₑₓ cation is 2+ or more.

3. The zinc rechargeable battery of claim 1, wherein
the low kₑₓ cation is Al³⁺, Sc³⁺, or a combination thereof.

4. The zinc rechargeable battery of claim 1, wherein
the low kₑₓ cation is present in the electrolyte and/or present on the surface of the negative electrode.

5. The zinc rechargeable battery of claim 1, wherein
a molal concentration of the low kₑₓ cation in the electrolyte about 0.1 m to about 5 m.

6. The zinc rechargeable battery of claim 1, wherein
a molal concentration of the low kₑₓ cation in the electrolyte is about 0.1 m to about 2.5 m.

7. The zinc rechargeable battery of claim 1, wherein
a molal concentration of zinc ion in the electrolyte is about 0.1 m to about 30 m.

8. The zinc rechargeable battery of claim 1, wherein
a molal concentration of zinc ion in the electrolyte is about 0.1 m to about 10 m.

9. The zinc rechargeable battery of claim 1, wherein
a molal concentration of the low kₑₓ cation is about 0.5 times or less of a molal concentration of zinc ion.

10. The zinc rechargeable battery of claim 1, wherein
a molal concentration of the low kₑₓ cation and a molal concentration of zinc ion in the electrolyte is about 1:2 to about 1:20.

11. The zinc rechargeable battery of claim 1, wherein
a molal concentration of the low kₑₓ cation and a molal concentration of zinc ion in the electrolyte is about 1:2 to about 1:10.

12. The zinc rechargeable battery of claim 1, wherein
the zinc salt includes an anion of [N(CF₃SO₂)₂]⁻, [N(C₂F₅SO₂)₂]⁻, [N(C₂F₅SO₂)(CF₃SO₂)]⁻, CF₃SO₃⁻, C₂F₅SO₃⁻, SO₄²⁻, Cl⁻, or CH₃CO₂⁻.

13. The zinc rechargeable battery of claim 1, wherein
in the electrolyte, the solvent includes an aqueous solvent.

14. The zinc rechargeable battery of claim 1, wherein
in the electrolyte, the solvent includes an organic solvent.

15. The zinc rechargeable battery of claim 1, wherein
in the electrolyte, the solvent is a mixed solvent of an aqueous solvent and an organic solvent.

16. The zinc rechargeable battery of claim 1, wherein
the negative electrode includes a negative electrode active material including a zinc metal, a zinc alloy, or a combination thereof, and
the zinc alloy includes at least one element selected from Ag, Al, Au, B, Ba, Ca, Ce, Co, Cr, Cu, F, Fe, Hg, In, Mg, Mn, Ni, P, S, Si, Sn, Sr, Ti, V, W, and Zr and zinc.

17. The zinc rechargeable battery of claim 1, wherein
the positive electrode includes an inorganic positive electrode active material, an organic positive electrode active material, or a combination thereof.

18. A zinc rechargeable battery, comprising
a positive electrode,
a zinc-containing negative electrode,
a separator between the positive electrode and the negative electrode, and an electrolyte,
wherein the electrolyte includes a solvent, a zinc salt, and a scandium cation (Sc³⁺).

19. The zinc rechargeable battery of claim 18, wherein
the scandium cation is present in the electrolyte and/or present on the surface of the negative electrode.

20. The zinc rechargeable battery of claim 18, wherein
a molal concentration of the scandium cation in the electrolyte about 0.1 m to about 5 m.

21. The zinc rechargeable battery of claim 18, wherein
a molal concentration of zinc ion in the electrolyte is about 0.1 m to about 10 m.

22. The zinc rechargeable battery of claim 18, wherein
a molal concentration of the scandium cation in the electrolyte is lower than the molal concentration of zinc ion.

23. The zinc rechargeable battery of claim 18, wherein
a molal concentration of the scandium cation and a molal concentration of zinc ion in the electrolyte is about 1:2 to about 1:20.

24. The zinc rechargeable battery of claim 18, wherein
in the electrolyte, the solvent includes an aqueous solvent.

25. The zinc rechargeable battery of claim 18, wherein
in the electrolyte, the solvent includes an organic solvent.

26. The zinc rechargeable battery of claim 18, wherein
in the electrolyte, the solvent is a mixed solvent of an aqueous solvent and an organic solvent.

27. The zinc rechargeable battery of claim 18, wherein
the negative electrode includes a negative electrode active material including a zinc metal, a zinc alloy, or a combination thereof, and
the zinc alloy includes at least one element selected from Ag, Al, Au, B, Ba, Ca, Ce, Co, Cr, Cu, F, Fe, Hg, In, Mg, Mn, Ni, P, S, Si, Sn, Sr, Ti, V, W, and Zr and zinc.

28. The zinc rechargeable battery of claim 18, wherein
the positive electrode includes an inorganic positive electrode active material, an organic positive electrode active material, or a combination thereof.
